(19) United States
(12) Patent Application Publication
(10) Pub. No.: US 2023/0347712 A1
(43) Pub. Date: Nov. 2, 2023

(54) VEHICLE HVAC SYSTEM

(71) Applicant: Oshkosh Corporation, Oshkosh, WI (US)

(72) Inventors: Josh Gentner, Oshkosh, WI (US); James Tebbe, Oshkosh, WI (US); Jon Zeamer, Oshkosh, WI (US); Jeremy Andringa, Oshkosh, WI (US); Greg Steffens, Oshkosh, WI (US); Jon Branson, Oshkosh, WI (US); Jeff Verhagen, Oshkosh, WI (US); Amanda Miller, Oshkosh, WI (US); Ryan Wolf, Oshkosh, WI (US)

(73) Assignee: Oshkosh Corporation, Oshkosh, WI (US)

(21) Appl. No.: 18/171,144

(22) Filed: Feb. 17, 2023

Related U.S. Application Data
(60) Provisional application No. 63/325,633, filed on Mar. 31, 2022.

(51) Int. Cl. B65F 3/02; B60H 1/00

(52) U.S. Cl. CPC B60H 1/00742; B60H 1/00821; B65F 3/02; B65F 2003/0279

(57) ABSTRACT

A refuse vehicle includes a chassis, a cab, a body assembly coupled with the chassis, and a lift assembly. The body assembly defines a refuse compartment. The lift assembly can be configured to engage a refuse container. The refuse vehicle further comprises a heating, ventilation, or air conditioning (HVAC) system that is configured to deliver air to the cab via a plurality of ducts. The refuse vehicle further includes a controller configured to receive data from one or more sensors, determine, based on the received data, that an interlock condition is present, and alter an operation of the HVAC system based on the interlock condition.

### CROSS REFERENCE TO RELATED PATENT APPLICATION

This application claims the benefit of and priority to U.S. Provisional Pat. Application No. 63/325,633, filed Mar. 31, 2022, which is incorporated herein by reference in its entirety.

### BACKGROUND

The present disclosure relates generally to vehicles. More specifically, the present disclosure relates to an HVAC system for a vehicle. In many modern vehicles (e.g., passenger cars, transport vehicles, commercial vehicles, on- or off-highway construction equipment, etc.), an HVAC system is included to condition the air inside of a vehicle cabin (i.e., an area where one or more passengers are present). For example, the HVAC system may control the temperature inside the cabin, recirculate and filter air distributed to the cabin, adjust the humidity inside the cabin, etc. However, many HVAC systems are inefficient and require significant energy expenditure to operate, which further reduces the fuel efficiency of internal combustion engine-powered vehicles or the state of charge of a battery of an electrified vehicle.

### SUMMARY

One embodiment relates to a refuse vehicle includes a chassis, a cab, a body assembly coupled with the chassis, and a lift assembly. The body assembly defines a refuse compartment. The lift assembly can be configured to engage a refuse container. The refuse vehicle further comprises a heating, ventilation, or air conditioning (HVAC) system that is configured to deliver air to the cab via a plurality of ducts. The refuse vehicle further includes a controller configured to receive data from one or more sensors, determine, based on the received data, that an interlock condition is present, and alter an operation of the HVAC system based on the interlock condition.

One embodiment relates to a control system for a heating, ventilation, or cooling (HVAC) system of a refuse vehicle. The control system can include a controller configured to control an operation of the HVAC system of the refuse vehicle. The HVAC system can be configured to provide heating or cooling energy to a cab of the refuse vehicle. The controller can include one or more processors and a memory storing instructions that, when executed by the one or more processors cause operations. The operations can include receiving data from one or more sensors regarding a condition of the cab of the refuse vehicle. The operations can further include detecting, based on the received data, that an interlock condition is present. The operations can further include altering, based on the detected interlock condition, the operation of the HVAC system.

One embodiment relates to a method of operating a heating, ventilation, or cooling (HVAC) system of a refuse vehicle. The method can include receiving, by a controller from one or more sensors, data regarding a condition of an interior of a cab of the refuse vehicle. The method can include detecting, by the controller and based on the data regarding the condition of the interior of the cab, that an interlock condition is present. The method can include causing, by the controller and based on the detected interlock condition, the HVAC system to operate in an interlock mode until the interlock condition is no longer satisfied.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left side view of a vehicle, according to an exemplary embodiment.

FIG. 2 is a perspective view of a chassis of the vehicle of FIG. 1.

FIG. 3 is a perspective view of the vehicle of FIG. 1 configured as a front-loading refuse vehicle, according to an exemplary embodiment.

FIG. 4 is a left side view of the front-loading refuse vehicle of FIG. 3 configured with a tag axle.

FIG. 5 is a perspective view of the vehicle of FIG. 1 configured as a side-loading refuse vehicle, according to an exemplary embodiment.

FIG. 6 is a right side view of the side-loading refuse vehicle of FIG. 5.

FIG. 7 is a top view of the side-loading refuse vehicle of FIG. 5.

FIG. 8 is a left side view of the side-loading refuse vehicle of FIG. 5 configured with a tag axle.

FIG. 9 is a perspective view of the vehicle of FIG. 1 configured as a mixer vehicle, according to an exemplary embodiment.

FIG. 10 is a perspective view of the vehicle of FIG. 1 configured as a fire fighting vehicle, according to an exemplary embodiment.

FIG. 11 is a left side view of the vehicle of FIG. 1 configured as an airport fire fighting vehicle, according to an exemplary embodiment.

FIG. 12 is a perspective view of the vehicle of FIG. 1 configured as a boom lift, according to an exemplary embodiment.

FIG. 13 is a perspective view of the vehicle of FIG. 1 configured as a scissor lift, according to an exemplary embodiment.

FIG. 14 is a schematic of a heating, ventilation, or air conditioning (HVAC) system of the vehicle of FIG. 1, according to an exemplary embodiment.

FIG. 15 is a top view of a cab of the vehicle of FIG. 1, according to an exemplary embodiment.

FIG. 16 is a schematic of a control system of the vehicle of FIG. 1, according to an exemplary embodiment.

FIG. 17 is a flow chart of a method of operating a heating, ventilation, and air-conditioning system of the vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle includes a vehicle HVAC system. The HVAC system can be configured to provide heating energy or cooling energy to the vehicle, filter air within a cab of the vehicle, control the humidity within the cab of the vehicle, or otherwise. In some embodiments, the HVAC system can create air curtains (a) in an opening created by an open vehicle door or (b) between various zones of the cab. The air curtains may be configured to prevent heating energy, cooling energy, humidity, etc. from escaping into an outdoor environment, for example. The HVAC system may also include a seat ventilation system configured to direct airflow into ducts within one or more seats of the cab. The HVAC system may be controlled by a control system. The control system may receive data from a variety of sources, such as sensors, operator input, or various other systems of the vehicle (e.g., a battery system, a fuel system, etc.)

### Overall Vehicle

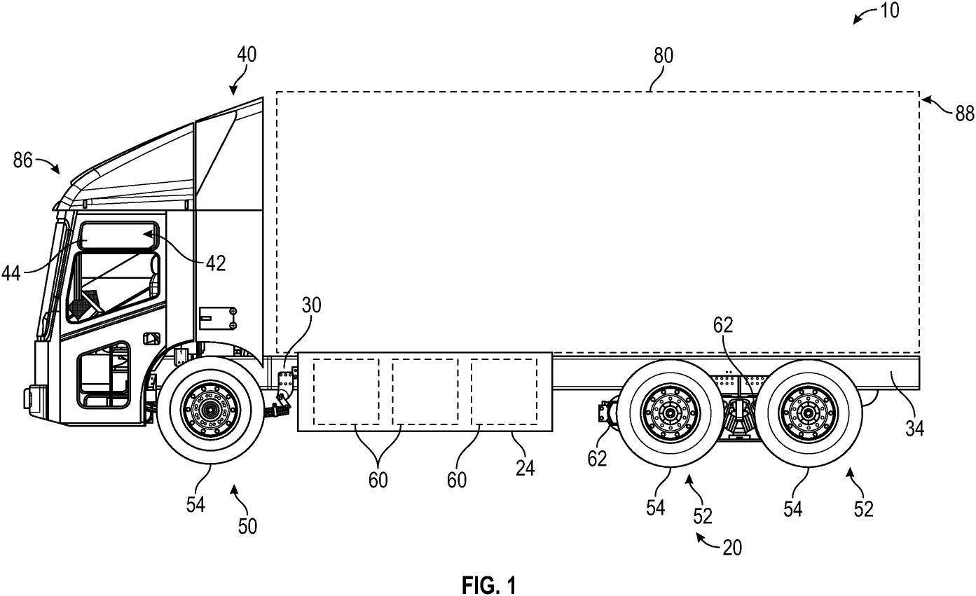

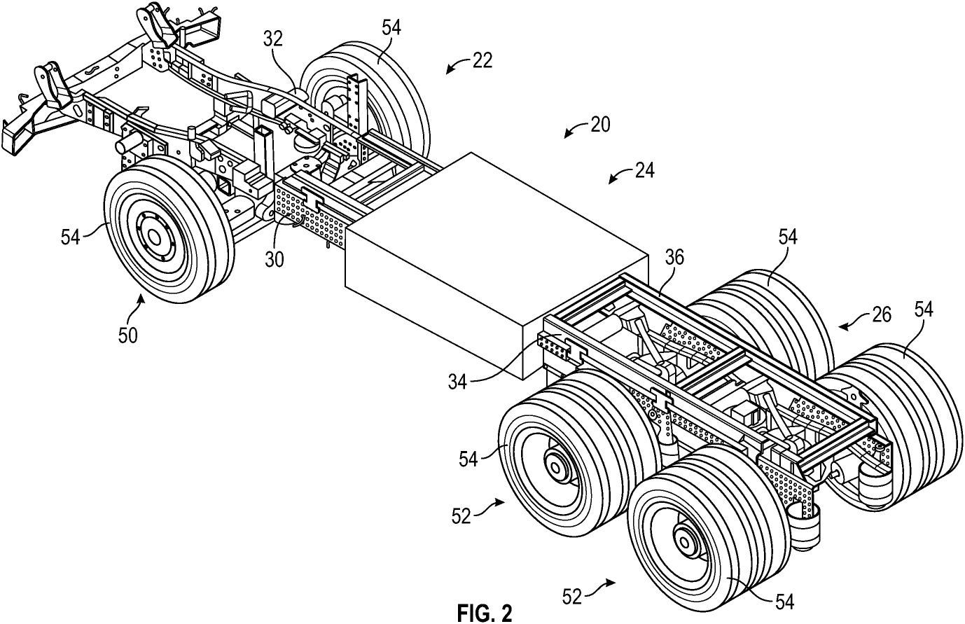

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles 52 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickelcadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

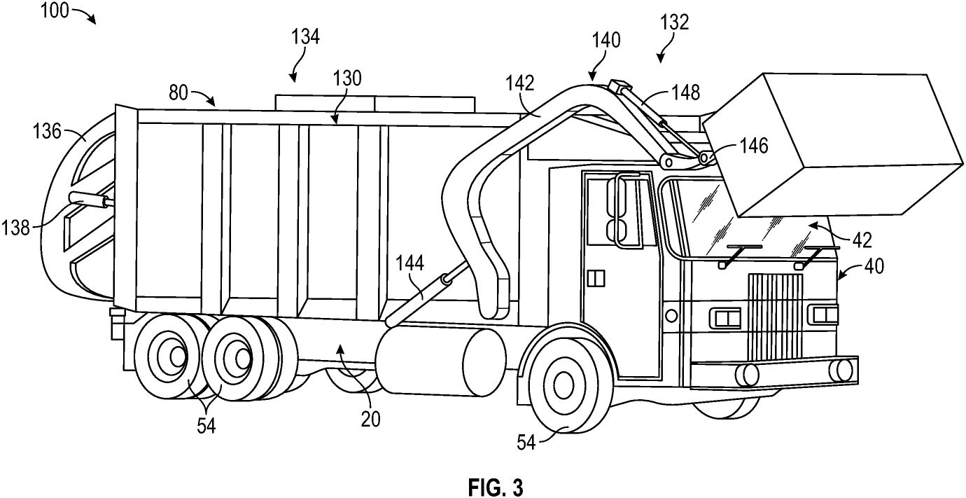

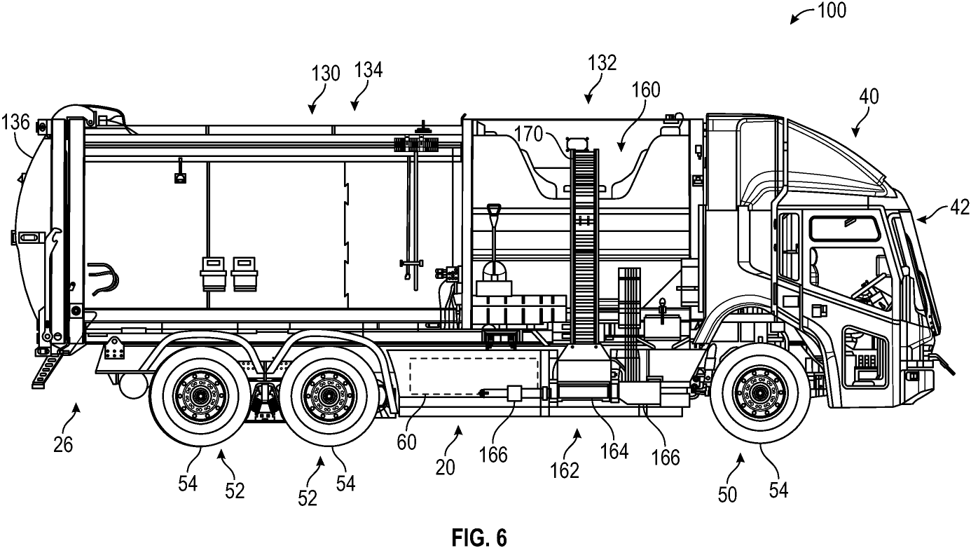

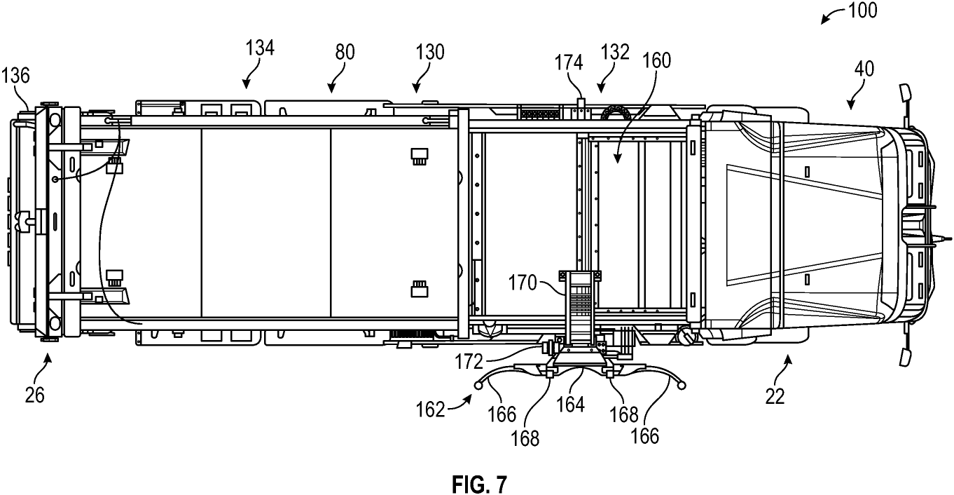

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-13 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### A. Front-Loading Refuse Vehicle

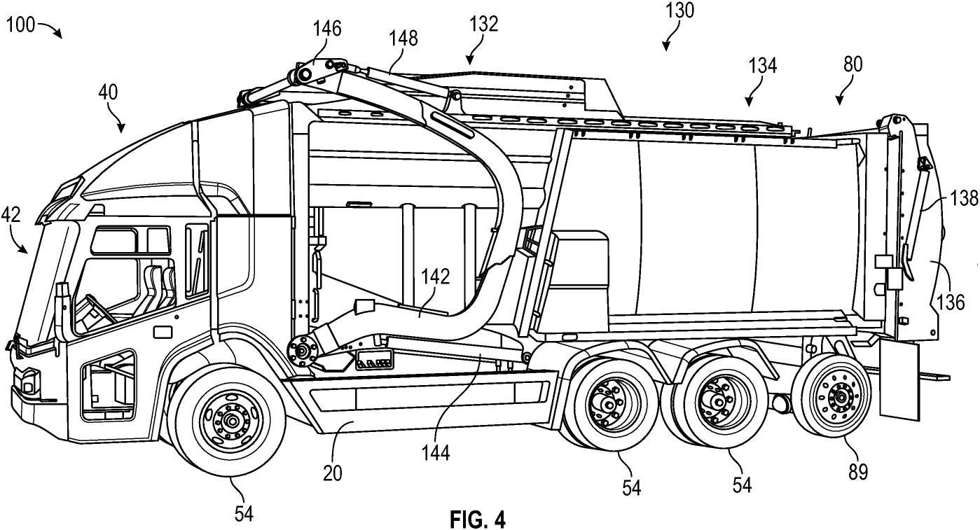

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 89, including a pair of wheel and tire assemblies 54. As shown, the tag axle 89 is positioned reward of the rear axles 52. The tag axle 89 can be selectively raised and lowered (e.g., by a hydraulic actuator) to selectively engage the wheel and tire assemblies 54 of the tag axle 89 with the ground. The tag axle 89 may be raised to reduce rolling resistance experienced by the refuse vehicle 100. The tag axle 89 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively couple the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### B. Side-Loading Refuse Vehicle

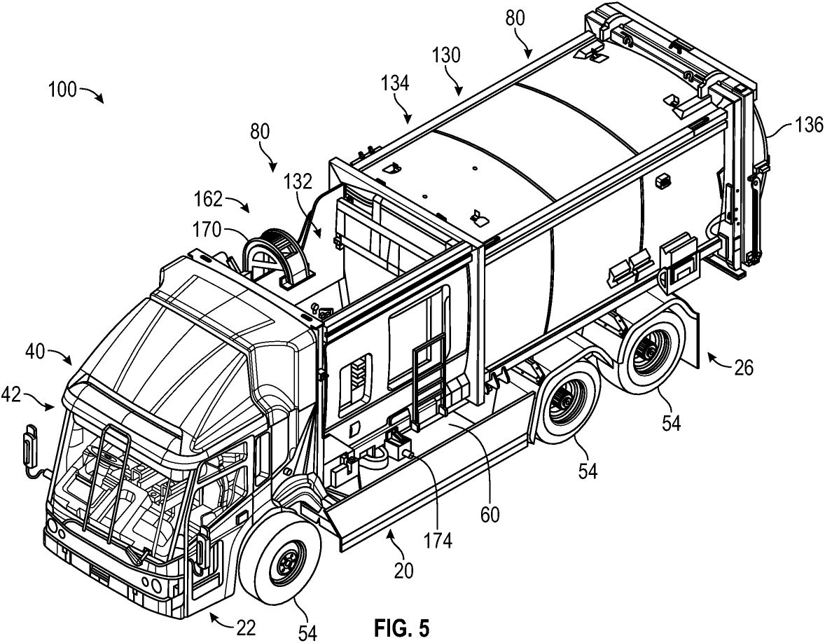

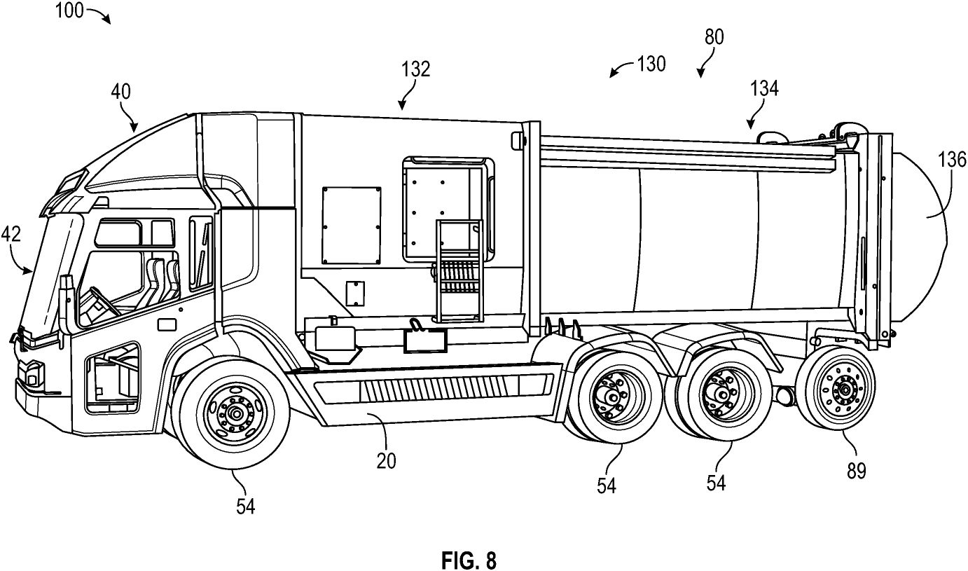

Referring now to FIGS. 5-8, an alternative configuration of the refuse vehicle 100 is shown according to an exemplary embodiment. Specifically, the refuse vehicle 100 of FIGS. 5-8 is configured as a side-loading refuse vehicle. The refuse vehicle 100 of FIGS. 5-8 may be substantially similar to the front-loading refuse vehicle 100 of FIGS. 3 and 4 except as otherwise specified herein. As shown in FIG. 8, the refuse vehicle 100 of FIGS. 5-7 may be is configured with a tag axle 89.

Referring still to FIGS. 5-8, the refuse vehicle 100 omits the lift assembly 140 and instead includes a side-loading lift assembly, shown as lift assembly 160, that extends laterally outward from a side of the refuse vehicle 100. The lift assembly 160 includes an interface assembly, shown as grabber assembly 162, that is configured to engage a refuse container (e.g., a residential garbage can) to selectively couple the refuse container to the lift assembly 160. The grabber assembly 162 includes a main portion, shown as main body 164, and a pair of fingers or interface members, shown as grabber fingers 166. The grabber fingers 166 are pivotally coupled to the main body 164 such that the grabber fingers 166 are each rotatable about a vertical axis. A pair of actuators (e.g., hydraulic motors, electric motors, etc.), shown as finger actuators 168, are configured to control movement of the grabber fingers 166 relative to the main body 164.

The grabber assembly 162 is movably coupled to a guide, shown as track 170, that extends vertically along a side of the refuse vehicle 100. Specifically, the main body 164 is slidably coupled to the track 170 such that the main body 164 is repositionable along a length of the track 170. An actuator (e.g., a hydraulic motor, an electric motor, etc.), shown as lift actuator 172, is configured to control movement of the grabber assembly 162 along the length of the track 170. In some embodiments, a bottom end portion of the track 170 is straight and substantially vertical such that the grabber assembly 162 raises or lowers a refuse container when moving along the bottom end portion of the track 170. In some embodiments, a top end portion of the track 170 is curved such that the grabber assembly 162 inverts a refuse container to dump refuse into the hopper volume 132 when moving along the top end portion of the track 170.

The lift assembly 160 further includes an actuator (e.g., a hydraulic cylinder, an electric linear actuator, etc.), shown as track actuator 174, that is configured to control lateral movement of the grabber assembly 162. By way of example, the track actuator 174 may be coupled to the chassis 20 and the track 170 such that the track actuator 174 moves the track 170 and the grabber assembly 162 laterally relative to the chassis 20. The track actuator 174 may facilitate repositioning the grabber assembly 162 to pick up and replace refuse containers that are spaced laterally outward from the refuse vehicle 100.

### C. Concrete Mixer Truck

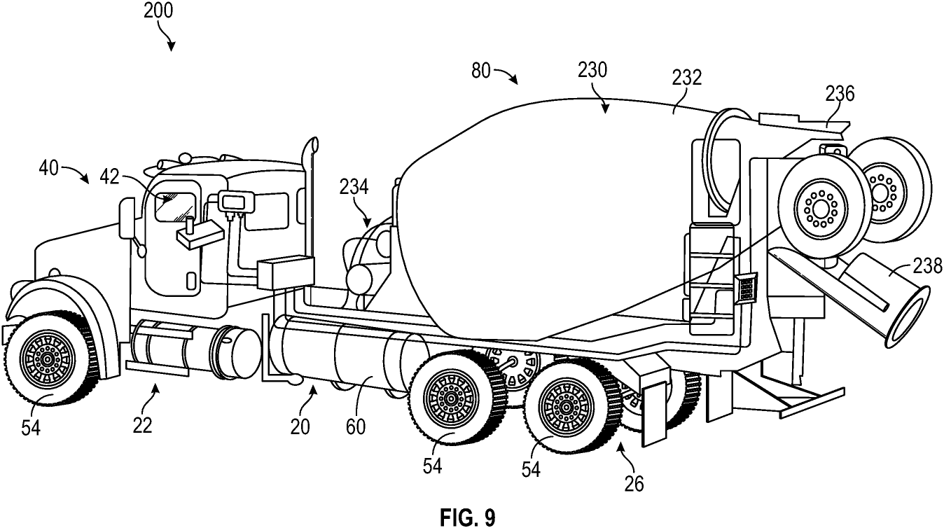

Referring now to FIG. 9, the vehicle 10 is configured as a mixer truck (e.g., a concrete mixer truck, a mixer vehicle, etc.), shown as mixer truck 200. Specifically, the mixer truck 200 is shown as a rear-discharge concrete mixer truck. In other embodiments, the mixer truck 200 is a front-discharge concrete mixer truck.

As shown in FIG. 9, the application kit 80 includes a mixing drum assembly (e.g., a concrete mixing drum), shown as drum assembly 230. The drum assembly 230 may include a mixing drum 232, a drum drive system 234 (e.g., a rotational actuator or motor, such as an electric motor or hydraulic motor), an inlet portion, shown as hopper 236, and an outlet portion, shown as chute 238. The mixing drum 232 may be coupled to the chassis 20 and may be disposed behind the cab 40 (e.g., at the rear and/or middle of the chassis 20). In an exemplary embodiment, the drum drive system 234 is coupled to the chassis 20 and configured to selectively rotate the mixing drum 232 about a central, longitudinal axis. According to an exemplary embodiment, the central, longitudinal axis of the mixing drum 232 may be elevated from the chassis 20 (e.g., from a horizontal plane extending along the chassis 20) at an angle in the range of five degrees to twenty degrees. In other embodiments, the central, longitudinal axis may be elevated by less than five degrees (e.g., four degrees, etc.). In yet another embodiment, the mixer truck 200 may include an actuator positioned to facilitate adjusting the central, longitudinal axis to a desired or target angle (e.g., manually in response to an operator input/command, automatically according to a control system, etc.).

The mixing drum 232 may be configured to receive a mixture, such as a concrete mixture (e.g., cementitious material, aggregate, sand, etc.), through the hopper 236. In some embodiments, the mixer truck 200 includes an injection system (e.g., a series of nozzles, hoses, and/or valves) including an injection valve that selectively fluidly couples a supply of fluid to the inner volume of the mixing drum 232. By way of example, the injection system may be used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum 232. The injection valve may facilitate injecting water and/or chemicals from a fluid reservoir (e.g., a water tank, etc.) into the mixing drum 232, while preventing the mixture in the mixing drum 232 from exiting the mixing drum 232 through the injection system. In some embodiments, one or more mixing elements (e.g., fins, etc.) may be positioned in the interior of the mixing drum 232, and may be configured to agitate the contents of the mixture when the mixing drum 232 is rotated in a first direction (e.g., counterclockwise, clockwise, etc.), and drive the mixture out through the chute 238 when the mixing drum 232 is rotated in a second direction (e.g., clockwise, counterclockwise, etc.). In some embodiments, the chute 238 may also include an actuator positioned such that the chute 238 may be selectively pivotable to position the chute 238 (e.g., vertically, laterally, etc.), for example at an angle at which the mixture is expelled from the mixing drum 232.

### D. Fire Truck

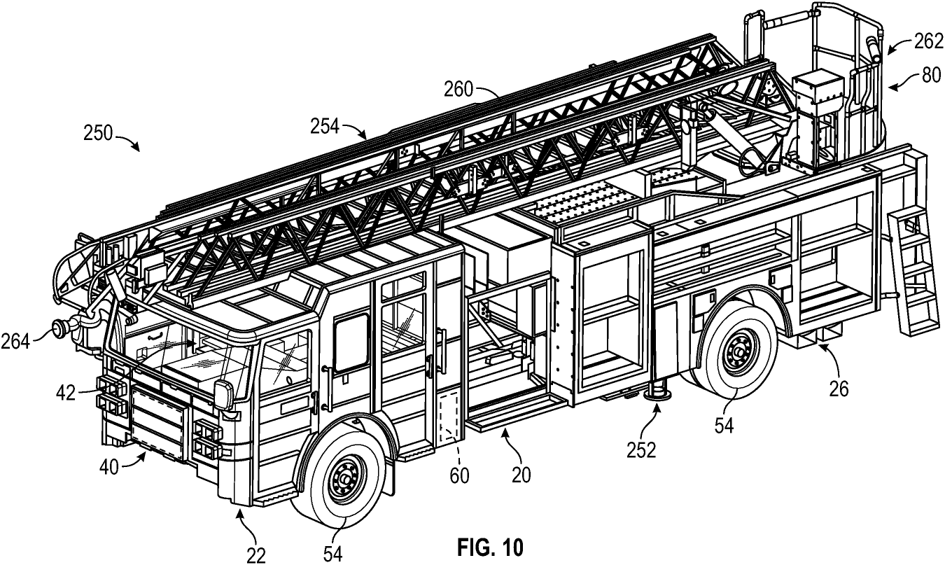

Referring now to FIG. 10, the vehicle 10 is configured as a fire fighting vehicle, fire truck, or fire apparatus (e.g., a turntable ladder truck, a pumper truck, a quint, etc.), shown as fire fighting vehicle 250. In the embodiment shown in FIG. 10, the fire fighting vehicle 250 is configured as a rear-mount aerial ladder truck. In other embodiments, the fire fighting vehicle 250 is configured as a mid-mount aerial ladder truck, a quint fire truck (e.g., including an on-board water storage, a hose storage, a water pump, etc.), a tiller fire truck, a pumper truck (e.g., without an aerial ladder), or another type of response vehicle. By way of example, the vehicle 10 may be configured as a police vehicle, an ambulance, a tow truck, or still other vehicles used for responding to a scene (e.g., an accident, a fire, an incident, etc.).

As shown in FIG. 10, in the fire fighting vehicle 250, the application kit 80 is positioned mainly rearward from the cab 40. The application kit 80 includes deployable stabilizers (e.g., outriggers, downriggers, etc.), shown as outriggers 252, that are coupled to the chassis 20. The outriggers 252 may be configured to selectively extend from each lateral side and/or the rear of the fire fighting vehicle 250 and engage a support surface (e.g., the ground) in order to provide increased stability while the fire fighting vehicle 250 is stationary. The fire fighting vehicle 250 further includes an extendable or telescoping ladder assembly, shown as ladder assembly 254. The increased stability provided by the outriggers 252 is desirable when the ladder assembly 254 is in use (e.g., extended from the fire fighting vehicle 250) to prevent tipping. In some embodiments, the application kit 80 further includes various storage compartments (e.g., cabinets, lockers, etc.) that may be selectively opened and/or accessed for storage and/or component inspection, maintenance, and/or replacement.

As shown in FIG. 10, the ladder assembly 254 includes a series of ladder sections 260 that are slidably coupled with one another such that the ladder sections 260 may extend and/or retract (e.g., telescope) relative to one another to selectively vary a length of the ladder assembly 254. A base platform, shown as turntable 262, is rotatably coupled to the chassis 20 and to a proximal end of a base ladder section 260 (i.e., the most proximal of the ladder sections 260). The turntable 262 may be configured to rotate about a vertical axis relative to the chassis 20 to rotate the ladder sections 260 about the vertical axis (e.g., up to 360 degrees, etc.). The ladder sections 260 may rotate relative to the turntable 262 about a substantially horizontal axis to selectively raise and lower the ladder sections 260 relative to the chassis 20. As shown, a water turret or implement, shown as monitor 264, is coupled to a distal end of a fly ladder section 260 (i.e., the most distal of the ladder sections 260). The monitor 264 may be configured to expel water and/or a fire suppressing agent (e.g., foam, etc.) from a water storage tank and/or an agent tank onboard the fire fighting vehicle 250, and/or from an external source (e.g., a fire hydrant, a separate water/pumper truck, etc.). In some embodiments, the ladder assembly 254 further includes an aerial platform coupled to the distal end of the fly ladder section 260 and configured to support one or more operators.

### E. ARFF Truck

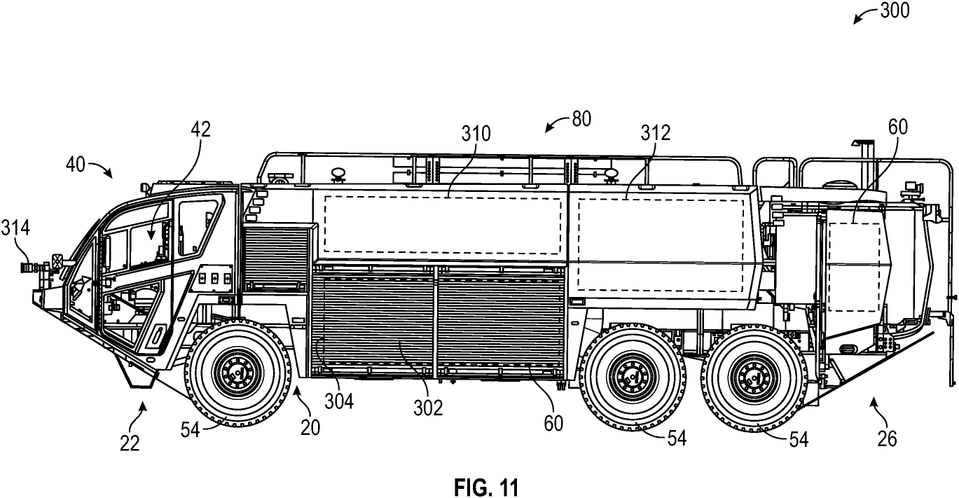

Referring now to FIG. 11, the vehicle 10 is configured as a fire fighting vehicle, shown as airport rescue and fire fighting (ARFF) truck 300. As shown in FIG. 11, the application kit 80 is positioned primarily rearward of the cab 40. As shown, the application kit 80 includes a series of storage compartments or cabinets, shown as compartments 302, that are coupled to the chassis 20. The compartments 302 may store various equipment or components of the ARFF truck 300.

The application kit 80 includes a pump system 304 (e.g., an ultra-high-pressure pump system, etc.) positioned within one of the compartments 302 near the center of the ARFF truck 300. The application kit 80 further includes a water tank 310, an agent tank 312, and an implement or water turret, shown as monitor 314. The pump system 304 may include a high pressure pump and/or a low pressure pump, which may be fluidly coupled to the water tank 310 and/or the agent tank 312. The pump system 304 may to pump water and/or fire suppressing agent from the water tank 310 and the agent tank 312, respectively, to the monitor 314. The monitor 314 may be selectively reoriented by an operator to adjust a direction of a stream of water and/or agent. As shown in FIG. 11, the monitor 314 is coupled to a front end of the cab 40.

### F. Boom Lift

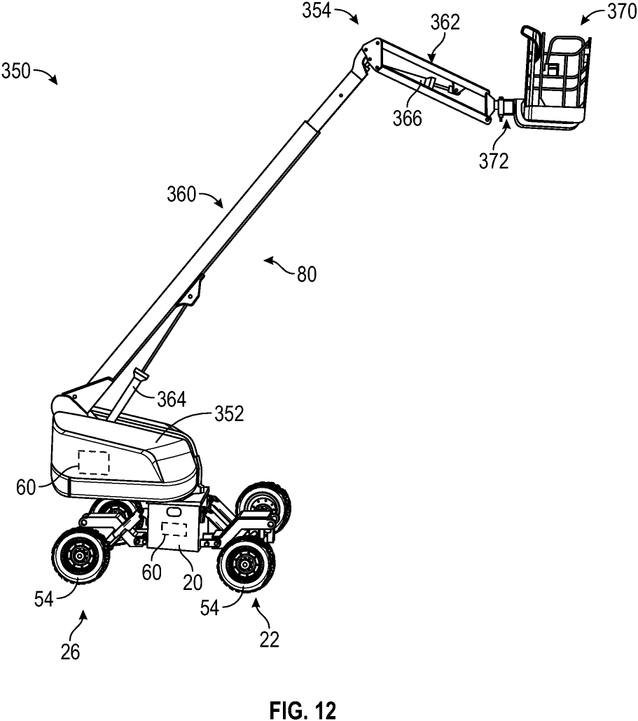

Referring now to FIG. 12, the vehicle 10 is configured as a lift device, shown as boom lift 350. The boom lift 350 may be configured to support and elevate one or more operators. In other embodiments, the vehicle 10 is configured as another type of lift device that is configured to lift operators and/or material, such as a skid-loader, a telehandler, a scissor lift, a fork lift, a vertical lift, and/or any other type of lift device or machine.

As shown in FIG. 12, the application kit 80 includes a base assembly, shown as turntable 352, that is rotatably coupled to the chassis 20. The turntable 352 may be configured to selectively rotate relative to the chassis 20 about a substantially vertical axis. In some embodiments, the turntable 352 includes a counterweight (e.g., the batteries) positioned near the rear of the turntable 352. The turntable 352 is rotatably coupled to a lift assembly, shown as boom assembly 354. The boom assembly 354 includes a first section or telescoping boom section, shown as lower boom 360. The lower boom 360 includes a series of nested boom sections that extend and retract (e.g., telescope) relative to one another to vary a length of the boom assembly 354. The boom assembly 354 further includes a second boom section or four bar linkage, shown as upper boom 362. The upper boom 362 may include structural members that rotate relative to one another to raise and lower a distal end of the boom assembly 354. In other embodiments, the boom assembly 354 includes more or fewer boom sections (e.g., one, three, five, etc.) and/or a different arrangement of boom sections.

As shown in FIG. 12, the boom assembly 354 includes a first actuator, shown as lower lift cylinder 364. The lower boom 360 is pivotally coupled (e.g., pinned, etc.) to the turntable 352 at a joint or lower boom pivot point. The lower lift cylinder 364 (e.g., a pneumatic cylinder, an electric linear actuator, a hydraulic cylinder, etc.) is coupled to the turntable 352 at a first end and coupled to the lower boom 360 at a second end. The lower lift cylinder 364 may be configured to raise and lower the lower boom 360 relative to the turntable 352 about the lower boom pivot point.

The boom assembly 354 further includes a second actuator, shown as upper lift cylinder 366. The upper boom 362 is pivotally coupled (e.g., pinned) to the upper end of the lower boom 360 at a joint or upper boom pivot point. The upper lift cylinder 366 (e.g., a pneumatic cylinder, an electric linear actuator, a hydraulic cylinder, etc.) is coupled to the upper boom 362. The upper lift cylinder 366 may be configured to extend and retract to actuate (e.g., lift, rotate, elevate, etc.) the upper boom 362, thereby raising and lowering a distal end of the upper boom 362.

Referring still to FIG. 12, the application kit 80 further includes an operator platform, shown as platform assembly 370, coupled to the distal end of the upper boom 362 by an extension arm, shown as jib arm 372. The jib arm 372 may be configured to pivot the platform assembly 370 about a lateral axis (e.g., to move the platform assembly 370 up and down, etc.) and/or about a vertical axis (e.g., to move the platform assembly 370 left and right, etc.).

The platform assembly 370 provides a platform configured to support one or more operators or users. In some embodiments, the platform assembly 370 may include accessories or tools configured for use by the operators. For example, the platform assembly 370 may include pneumatic tools (e.g., an impact wrench, airbrush, nail gun, ratchet, etc.), plasma cutters, welders, spotlights, etc. In some embodiments, the platform assembly 370 includes a control panel (e.g., a user interface, a removable or detachable control panel, etc.) configured to control operation of the boom lift 350 (e.g., the turntable 352, the boom assembly 354, etc.) from the platform assembly 370 or remotely. In other embodiments, the platform assembly 370 is omitted, and the boom lift 350 includes an accessory and/or tool (e.g., forklift forks, etc.) coupled to the distal end of the boom assembly 354.

### G. Scissor Lift

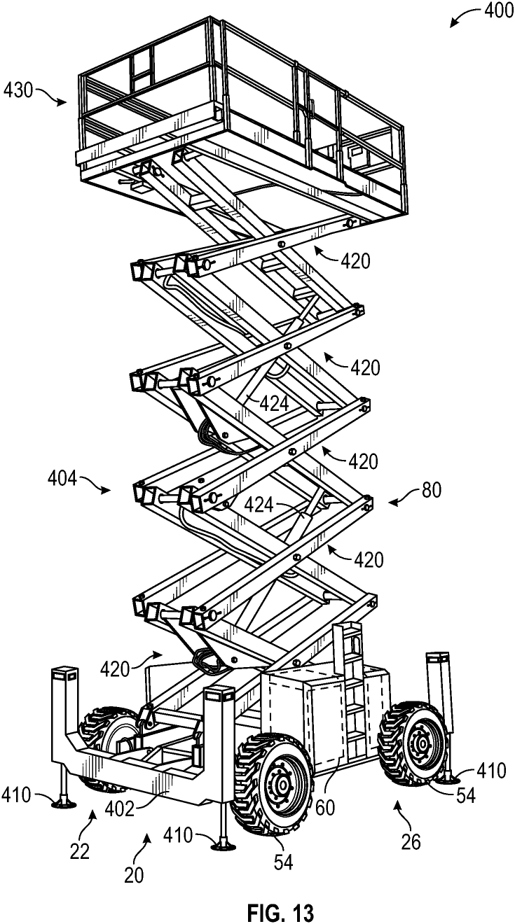

Referring now to FIG. 13, the vehicle 10 is configured as a lift device, shown as scissor lift 400. As shown in FIG. 13, the application kit 80 includes a body, shown as lift base 402, coupled to the chassis 20. The lift base 402 is coupled to a scissor assembly, shown as lift assembly 404, such that the lift base 402 supports the lift assembly 404. The lift assembly 404 is configured to extend and retract, raising and lowering between a raised position and a lowered position relative to the lift base 402.

As shown in FIG. 13, the lift base 402 includes a series of actuators, stabilizers, downriggers, or outriggers, shown as leveling actuators 410. The leveling actuators 410 may extend and retract vertically between a stored position and a deployed position. In the stored position, the leveling actuators 410 may be raised, such that the leveling actuators 410 do not contact the ground. Conversely, in the deployed position, the leveling actuators 410 may engage the ground to lift the lift base 402. The length of each of the leveling actuators 410 in their respective deployed positions may be varied in order to adjust the pitch (e.g., rotational position about a lateral axis) and the roll (e.g., rotational position about a longitudinal axis) of the lift base 402 and/or the chassis 20. Accordingly, the lengths of the leveling actuators 410 in their respective deployed positions may be adjusted to level the lift base 402 with respect to the direction of gravity (e.g., on uneven, sloped, pitted, etc. terrain). The leveling actuators 410 may lift the wheel and tire assemblies 54 off of the ground to prevent movement of the scissor lift 400 during operation. In other embodiments, the leveling actuators 410 are omitted.

The lift assembly 404 may include a series of subassemblies, shown as scissor layers 420, each including a pair of inner members and a pair of outer members pivotally coupled to one another. The scissor layers 420 may be stacked atop one another in order to form the lift assembly 404, such that movement of one scissor layer 420 causes a similar movement in all of the other scissor layers 420. The scissor layers 420 extend between and couple the lift base 402 and an operator platform (e.g., the platform assembly 430). In some embodiments, scissor layers 420 may be added to, or removed from, the lift assembly 404 in order to increase, or decrease, the fully extended height of the lift assembly 404.

Referring still to FIG. 13, the lift assembly 404 may also include one or more lift actuators 424 (e.g., hydraulic cylinders, pneumatic cylinders, electric linear actuators such as motor-driven leadscrews, etc.) configured to extend and retract the lift assembly 404. The lift actuators 424 may be pivotally coupled to inner members of various scissor layers 420, or otherwise arranged within the lift assembly 404.

A distal or upper end of the lift assembly 404 is coupled to an operator platform, shown as platform assembly 430. The platform assembly 430 may perform similar functions to the platform assembly 370, such as supporting one or more operators, accessories, and/or tools. The platform assembly 430 may include a control panel to control operation of the scissor lift 400. The lift actuators 424 may be configured to actuate the lift assembly 404 to selectively reposition the platform assembly 430 between a lowered position (e.g., where the platform assembly 430 is proximate to the lift base 402) and a raised position (e.g., where the platform assembly 430 is at an elevated height relative to the lift base 402). Specifically, in some embodiments, extension of the lift actuators 424 moves the platform assembly 430 upward (e.g., extending the lift assembly 404), and retraction of the lift actuators 424 moves the platform assembly 430 downward (e.g., retracting the lift assembly 404). In other embodiments, extension of the lift actuators 424 retracts the lift assembly 404, and retraction of the lift actuators 424 extends the lift assembly 404.

### Vehicle HVAC System

Various embodiments of the vehicles described above can also include a vehicle HVAC system. The HVAC system can be configured to provide heating energy or cooling energy to the vehicle, filter air within a cab of the vehicle, control the humidity within the cab of the vehicle, or otherwise. In some embodiments, the HVAC system can create air curtains (a) in an opening created by an open vehicle door or (b) between various zones of the cab. The air curtains may be configured to prevent heating energy, cooling energy, humidity, etc. from escaping into an outdoor environment, for example. The HVAC system may also include a seat ventilation system configured to direct airflow into ducts within one or more seats of the cab. The HVAC system may be controlled by a control system. The control system may receive data from a variety of sources, such as sensors, operator input, or various other systems of the vehicle (e.g., batteries 60).

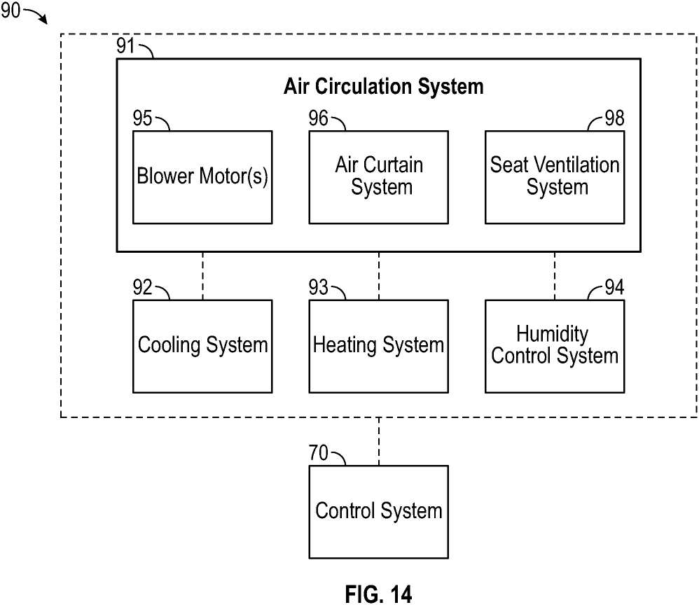

Referring now to FIGS. 14-17, an HVAC system 90 of the vehicle 10 and related components are shown, according to an exemplary embodiment. In various embodiments, the vehicle 10 may also include an HVAC (heating, ventilation, or air-conditioning) system 90. The HVAC system 90 may provide heating energy, cooling energy, conditioned air, airflow etc. to the cab 40 of the vehicle 10. In general, the HVAC system 90 may regulate the temperature, air quality, and humidity of the air within the cab interior 42 in order to maintain a desired level of comfort. Furthermore, the HVAC system 90 may be configured to circulate filtered and/or sterilized air within the cab interior 42, according to an exemplary embodiment. In various embodiments, the HVAC system 90 may be electrically coupled to the batteries 60 of the vehicle 10, particularly in vehicles 10 that are powered by batteries 60 and/or drive motors 62. In other embodiments, the HVAC system 90 may be operationally coupled to the primary driver of the vehicle 10 (e.g., an internal combustion engine) such that the HVAC system 90 is powered by the primary driver.

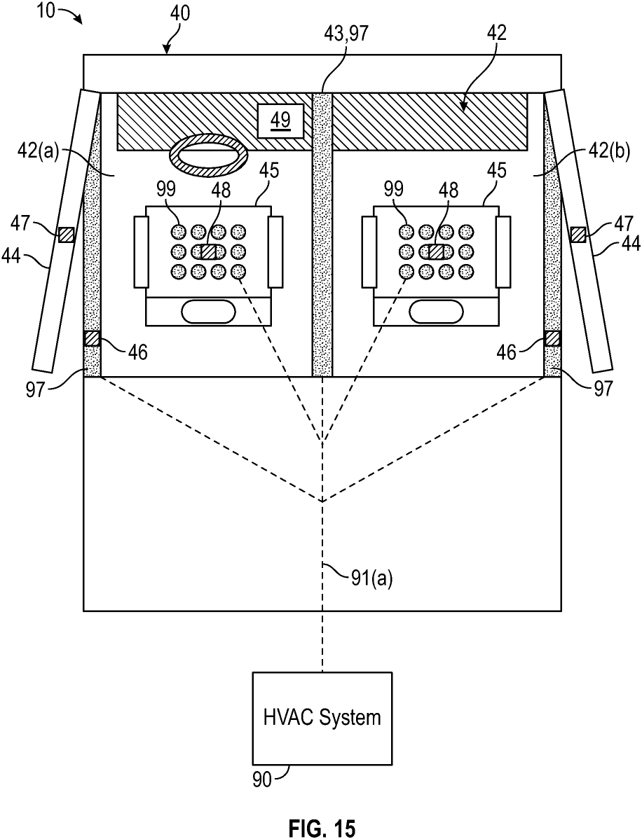

As shown in FIG. 14, the HVAC system may include an air circulation system 91, a cooling system 92, a heating system 93 and a humidity control system 94. The air circulation system 91 may include one or more blower motors 95, an air curtain system 96, and a seat ventilation system 98. The air circulation system 91 may further include a plurality of ducts 91(a), as shown in FIG. 15. According to an exemplary embodiment, the various components and sub-systems of the HVAC system 90 may be positioned variously on the vehicle 10, such as within the cab interior 42, on the chassis 20, or otherwise. Furthermore, the HVAC system 90 may include more or fewer of the components and sub-systems shown in FIG. 14.

The cooling system 92 may be configured to generate cooling energy for use in cooling the cab interior 42, according to an exemplary embodiment. The cooling system may use electrical energy from the batteries 60 to operate an air conditioner that includes a compressor, evaporator, and a condenser to cool refrigerant. The cooled refrigerant may then be used to cool air that is circulated into the cab interior 42 via ducts 91(a). The cooling system 92 may operate similar to a conventional automotive air conditioner, for example. In various embodiments, the cooling system 92 is configured to convert electrical power or some other energy source into cooling energy, which may be provided to the cab interior 42 via some fluid, such as air, water, coolant, or otherwise.

The heating system 93 may be configured to generate heating energy for use in heating the cab interior 42, according to an exemplary embodiment. In one embodiment, the heating system 93 may include a resistive heater that converts electrical energy into heating energy. In another embodiment, the heating system 93 may include a heat exchanger, or heater core, or some other heating device that uses heating energy generated by a primary driver (i.e., internal combustion engine) of the vehicle 10 to heat coolant, which is then circulated to the cab interior 42 or used to heat air that is provided to the cab interior 42, for example. In yet another embodiment, the heating system 93 may include a heat pump that includes a compressor, a condenser, and an evaporator, to generate heating energy. In various embodiments, the heating system 93 may be configured to convert electrical power or some other energy source into heating energy, which may then be provided to the cab interior 42 via some fluid, such as air, water, coolant, or otherwise.

In some embodiments, the heating system 93 can also be configured to provide heating energy to one or more windows of the cab 40. For example, the heating system 93 may include a plurality of resistive heating elements within window glass that, when powered with electrical energy, generates heat that can be used to defrost the one or more windows. In such examples, the resistive heating elements may be small, thin, and/or fibrous and may be formed within the windows (e.g., between a first pane and second pane of window glass). In another embodiment, the heating system 93 can be configured to defrost one or more windows of the cab 40 by providing hot or warm air to the windows of the cab 40 using a plurality of air ducts 91(a), as is discussed in detail below.

The humidity control system 94 may be configured to monitor and control the humidity of the air within the cab interior 42, according to an exemplary embodiment. The humidity control system 94 may include a hygrometer, a humidifier, a dehumidifier, or some combination thereof. The humidity control system 94 may be configured to monitor the humidity level within the cab interior 42 using the hygrometer. The humidity level may also be increased or decreased using the humidifier and dehumidifier, respectively.

As noted above, the air circulation system 91 may include a plurality of ducts 91(a) (shown in FIG. 15), one or more blower motors 95, an air curtain system 96, and a seat ventilation system 98. The one or more blower motors 95 may be configured to direct air through the one or more of the plurality of ducts 91(a) in order to direct air to the cab interior 42, according to an exemplary embodiment. The blower motor 95 may be a single speed, multispeed, or variable speed blower motor, as is well understood in the heating, ventilation, and air conditioning arts.

The plurality of ducts 91(a) may be selectively opened and closed via baffles within the ducts 91(a) or with vents positioned within the cab interior 42. The baffles and/or vents may be manually operated in some embodiments. In other embodiments, the baffles and/or vents may automatically operate via electric motor or some other means in response to a command from the control system 70, as is discussed further below. It should be understood that the ducts 91(a) shown in FIG. 15 merely show a fluid connection between the HVAC system 90 and the cab interior 42; FIG. 15 is not intended to depict any particular plumbing arrangement for the ducts 91(a).

The plurality of ducts 91(a) can be used to move or direct heated or cooled air throughout the cab interior 42. For example, the plurality of ducts 91(a) can direct air towards one or more windows of the doors 44 to defrost the windows. In another example, the plurality of ducts 91(a) can provide cooling energy directed at an operator positioned within one of the seats 45. In yet another example, the plurality of ducts 91(a) can be configured to direct heating air towards a front windscreen and/or sunroof of the cab 40 in order to defrost the front windscreen and/or sunroof.

The air curtain system 96 may be configured to create one or more air curtains within the cab interior 42, such as the air curtains 97 shown in FIG. 15. More specifically, the air curtain system may be configured to direct a curtain of air from a ceiling, door sill, door opening, or door frame of the cab 40. The air curtain system 96 can cause air to flow against (e.g., on) or proximate to the ceiling, door sill, door opening, or door frame in a downward direction, an upward direction, a horizontal direction, or some other direction, according to one example. In various embodiments, the air of the air curtain 97 may be sufficiently strong (i.e., sufficient volume and velocity) to prevent or reduce the loss of heat across the air curtain. For example, heated air or cooled air can be substantially (e.g., ± 90%) prevented from crossing through the air curtain such that a temperature gradient between opposite sides of the air curtain is reduced. Moreover, the air curtain system 96 may be configured to blow air to create the air curtain 97 at a sufficient velocity to prevent contaminants, horizontal winds, particulate matter, fumes, etc. from crossing the air curtain 97. According to an exemplary embodiment, the air curtain system 96 blows air in a substantially downwards direction (e.g., 0°-20° from a vertical direction) at a velocity of 5-100 ft/s, where the velocity is measured at a lower-most point of the air curtain 97 (e.g., where the air curtain 97 contacts a floor surface of the cab 40). In other embodiments, the air curtain system 96 may blow air at different angles relative to a vertical direction or at a different velocity.

The air curtain system 96 may utilize ducts 91(a) to create the air curtain 97 or may use additional ducts, nozzles, or some combination thereof. For example, the air curtain system 96 can include a plurality of narrow, elongated ducts positioned proximate a ceiling of the cab interior 42 and pointed in in a downwards direction. Air can be forced through the ducts to create an air curtain 97 comprising a powerful stream of air sufficient to prevent heating energy, cooling energy, fumes, contaminants, etc., from crossing from one side of the air curtain 97 to another. The air curtain system 96 may use the one or more blower motors 95 described above, or may use other blower motors or similar devices specific to the air curtain system 96, namely blower motors capable of creating airflow of a sufficient velocity and volume. In some embodiments, the air curtain system 96 may be a recirculating air curtain system. In other embodiments, the air curtain system 96 can be a non-recirculating air curtain system.

In various embodiments, the air curtain 97 produced by the air curtain system 96 may be comprised of a heated stream of air. Particularly in cold climates where a temperature within the cab 40 exceeds an ambient temperature, the heated stream of air may reduce a temperature differential between the air inside the cab interior 42 and the air curtain 97, which may reduce heat loss through the air curtain 97, according to an exemplary embodiment.

The seat ventilation system 98 may be configured to provide air to a plurality of seat ducts 99 formed in the seats 45 within the cab 40. More specifically, the seat ventilation system 98 may direct air through a plurality of ducts that blow air through a plurality of seat ducts 99 formed within a bottom and a back of the seats 45 to cool or warm a passenger occupying the seat. In one example, the seat ventilation system 98 and seat ducts 99 can be operationally coupled with the air circulation system 91, cooling system 92, heating system 93, humidity control system 94, and blower motor(s) 95, in order to deliver heated, cooled, and/or humidity-controlled air through the seat ducts 99. The seat ducts 99 can be fluidly coupled with the ducts 91(a) of the air circulation system, according to one embodiment.

In another embodiment, the seat ducts 99 may not be coupled with the ducts 91(a), and may instead receive air via another duct specific to the seat ventilation system 98. In such embodiments, the seat ventilation system 98 can include a blower motor, cooling system, heating system, and/or other components that are separate from (e.g., independent of) the blower motor 95, cooling system 92, and heating system 93 as discussed above. Put another way, the seat ventilation system 98 can include its own components and can operate independently of the rest of the HVAC system 90. In such examples, a blower motor, cooling system, heating system, etc. can be in fluid communication with the seat ducts 99 and can be contained within the seat 45 or otherwise proximate to the seat 45. In another example, a blower motor configured to provide air through the seat ducts 99 can be contained within the seat bottom or seat back, while a heating system and cooling system can be positioned underneath the seat 45 or elsewhere in the cab 40. The seat ventilation system 98 may operate separate from the air circulation system 91, cooling system 92, heating system 93, humidity control system 94, and blower motor(s) 95, and may instead include an additional blower motor, heating element, cooling element, humidity control device, etc. to provide heated, cooled, and/or humidity-controlled air to the seat ducts 99.

Referring now to FIG. 15, a cab 40 of the vehicle 10 is shown. The cab 40 can include two doors 44, each door having at least one window. The cab interior 42 includes one or more seats 45, and operator controls 49. The cab 40 includes a cab interior 42 that further includes a first zone 42(a) and a second zone 42(b). According to an exemplary embodiment, each of the zones 42(a) and 42(b) includes a single seat 45. Each of the zones 42(a) and 42(b) may be associated with a single occupant when the cab 40 is occupied. As will be discussed in detail below, the HVAC system 90 may selectively provide cooling energy and heating energy to each of the zones 42(a) and 42(b) independently, which allows an occupant to specify personal temperature and humidity preferences. Moreover, the control system 70 may control the HVAC system 90 in connection with each zone 42(a) and 42(b) to reduce energy waste and bolster the efficiency of the HVAC system 90 (and overall vehicle).

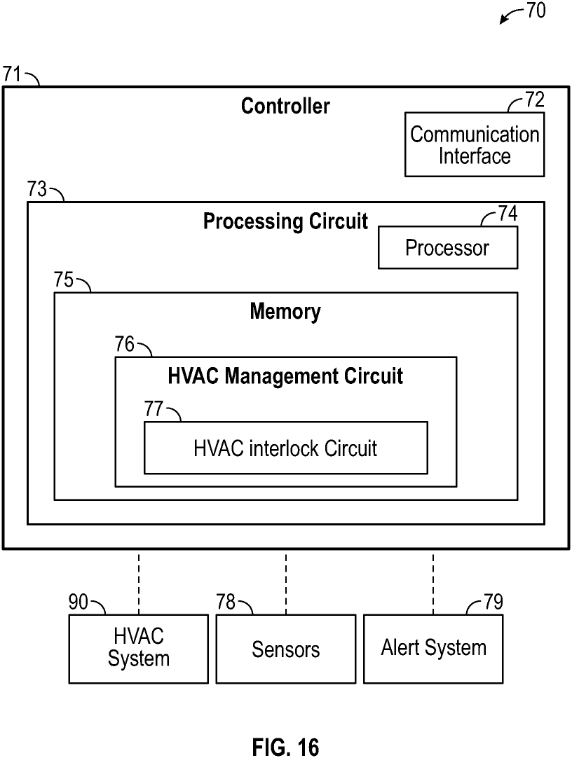

Positioned variously throughout the cab 40 and cab interior 42 are a plurality of sensors configured to facilitate control of the HVAC system 90 via the control system 70. For example, the cab 40 may include a plurality of door sensors 46 that are configured to determine whether a door 44 is open (i.e., ajar) or closed. The cab 40 can also include one or more window sensors 47 that are configured to determine whether and to what extent a window is open. Furthermore, the cab 40 may include one or more occupancy sensors 48 configured to detect the presence of one or more occupants within the cab interior 42, namely within zones 42(a) and 42(b). The various sensors 46, 47, and 48 will be discussed in detail below with reference to FIG. 16.

As noted above, the cab 40 and cab interior 42 may include various components related to the HVAC system. For example, the cab interior may include a plurality of air curtains 97. The air curtains 97 may separate each zone 42(a) and 42(b) from either an adjacent zone or an external environment (i.e., outside of the cab 40), according to an exemplary embodiment. As shown in FIG. 15, an air curtain 97 may be created by air curtain ducts or nozzles positioned in an opening of the cab 40 created by a door 44 in an open position. In another embodiment, an air curtain 97 may be created by air curtain ducts or nozzles positioned in between a seat 45 and the corresponding door 44 of the cab 40 so that the air curtain 97 is positioned between an outside environment and the cab interior 42 (i.e., one or more respective zone 42(a) or 42(b)). In this way, the heating energy, cooling energy, etc. within the cab interior 42 or a zone 42(a) or 42(b) of the cab interior 42 will be retained within the cab interior 42 rather than passing through the door opening to the outside environment. In another embodiment, an air curtain 97 may be created by one or more air curtain ducts or nozzles positioned proximate to the window of the door 44 in order to prevent heating energy, cooling energy, etc. from passing through an open window. As shown in FIG. 15, a door or window air curtain 97 may be positioned proximate to both of the doors 44 shown on the cab. Of course, in vehicles 10 having a cab 40 with more or fewer doors, more or fewer air curtains 97 may be used for a similar purpose.

The cab interior 42 may also include another air curtain 97 that separates the various zones 42(a) and 42(b) of the cab interior 42. According to an exemplary embodiment, the air curtain system 96 may separate zone 42(a) from zone 42(b) may by creating an air curtain 97 that divides the two zones 42(a) and 42(b). This air curtain 97 can reduce an amount of heating energy, cooling energy, humidity, fumes, pathogens, etc. that can move from one zone 42(a), 42(b) to another zone 42(b), 42(a), according to an exemplary embodiment. Accordingly, an occupant in one zone 42(a), 42(b) may set a preferred temperature or humidity, while the occupant in zone 42(b), 42(a) may set a different preferred temperature or humidity. The air curtain 97 will thus limit or prevent one occupant’s preferences from affecting the other’s zone. In another example, the air curtain 97 may allow the HVAC system 90 to operate only within one or more zones of a plurality of zones within the cab interior 42 when the cab is not fully occupied. For example, if an occupant is present in zone 42(a), but no occupant is present in zone 42(b), the air curtain 97 may be created to effectively reduce the area of the cab interior 42, thereby reducing the amount of heating or cooling energy that must be provided to the cab interior 42 to satisfy the occupant. As will be appreciated, cab interiors 42 of other vehicles 10 may have more or fewer zones, and may thus include an air curtain system configured to create additional air curtains 97 to separate the more or fewer zones.

In some embodiments, the cab 40 can include a physical divider 43. The divider 43 may be configured to separate the zone 42(a) from zone 42(b) by creating a physical boundary rather than using an air curtain 97, for example. As noted above, an air curtain 97 may be used to divide zone 42(a) from zone 42(b). The physical divider 43 may also be used to separate zone 42(a) from 42(b) in order to prevent heating energy, cooling energy, humidity, fumes, pathogens, contaminants, etc. from crossing from one zone 42(a), 42(b) to another zone 42(b), 42(a). The physical divider 43 may be deployed from a ceiling, a rear wall, or a front wall or windshield of the cab interior 42, according to an exemplary embodiment. For example, the divider 43 may be a rollable transparent vinyl sheet that is fixed at one end to the ceiling of the cab interior 42. A free end of the rollable transparent vinyl sheet may drop downwards towards a floor of the cab interior 42 to create a deployed divider 43, according to one embodiment. In another embodiment, the divider 43 may be a rigid plexiglass structure dividing the cab interior 42 into the two zones 42(a) and 42(b). In such embodiments, the divider 43 is not selectively deployable, but instead is fixedly coupled with the cab interior 42. In various embodiments, the divider 43 may include an opening, window, or passageway that can be selectively opened or closed to permit access from one zone 42(a), 42(b) to another 42(b), 42(a).

The seats 45 may include a plurality of seat ducts 99, as discussed above. The seat ducts 99 may be configured to provide air to the seats 45 at various locations (i.e., via the seat bottom or the seat back). As shown in FIG. 15, a plurality of seat ducts 99 may be positioned on a bottom of the seat 45 in order to provide cooled, heated, or humidity-controlled air to an occupant of the seat 45. In another example, the seat ducts 99 can be positioned in a seat back, a headrest, an arm rest, a seat bolster, etc. of the seats 45. In some embodiments, a plurality of small seat ducts 99 may be used. In other embodiments, the one or more seat ducts 99 may deliver cooled, heated, or humidity-controlled air to the seat 45 via a plurality of small perforations, passageways, etc. in the fabric or upholstery of the seat 45. In some embodiments, the seat ducts 99 may be configured to operate only when an occupant is present in the seat 45, as indicated by an occupancy sensor 48.

Referring now to FIG. 16, a control system 70 is shown. According to an exemplary embodiment, the HVAC system 90 may be operated by at least in part by control system 70. In general, the control system 70 may be configured to control various operations of the HVAC system 90, such as cooling operations, heating operations, air-circulation operations, ventilation operations, air-curtain operations, etc. as will be described in detail below. The control system 70 may include a controller 71 that is communicably coupled to the HVAC system 90. The control system 70 may also include or be communicably coupled to one or more sensors 78 and an alert device 79. The controller 71 may include a communication interface 72 and a processing circuit 73. The processing circuit may include a processor 74 and a memory 75. The memory 75 may include an HVAC management circuit 76 and an HVAC interlock circuit 77.

In some embodiments the HVAC management circuit 76 and the HVAC interlock circuit 77 may comprise application-specific circuitry that is not stored in the memory 75. In yet another embodiment, the HVAC management circuit 76 and the HVAC interlock circuit 77 may comprise computer-executable code that is stored in one or more memory devices located remotely from the vehicle 10 or on the vehicle 10. In some embodiments, the HVAC management circuit 76 may include the HVAC interlock circuit 77. In other embodiments, the HVAC management circuit 76 may be separate from the HVAC interlock circuit 77. According to an exemplary embodiment, and as discussed above, the controller 71 is configured to control and monitor (i.e., by receiving data from sensors 78, the HVAC system 90, or other vehicle systems) and control the operation of the HVAC system 90 and any auxiliary systems. According to an exemplary embodiment, the controller 71 may specifically monitor and control the operation of the HVAC system 90 in order to bolster the efficiency of the HVAC system 90, maintain a state of charge of the batteries 60 (i.e., by controlling the power drawn by the HVAC system 90), or reduce the risk of the spread of airborne disease, for example. It should be understood that the controller 71 can monitor and control the operation of the HVAC system 90 for any number of other purposes.

As noted above, the controller 71 may include or be communicably coupled to one or more sensors 78. The one or more sensors 78 may be devices configured to measure, record, and monitor various parameters involving the HVAC system 90. According to an exemplary embodiment, the sensors 78 may include a variety of sensors positioned within or proximate to the cab 40. More specifically, the sensors 78 may include a door sensor 46, a window sensor 47, and an occupancy sensor 48, according to an exemplary embodiment. As noted above, the door sensor 46 can be configured to determine if a door of the vehicle 10 is open (i.e., ajar), closed, etc. Relatedly, the window sensor 47 can be configured to determine if a window of the door (or other window associated with the cab 40) is open, closed, etc. The door sensor 46 and the window sensor 47 may be contact sensors (i.e., switches), position sensors (linear, rotational, etc.), or some other measurement device, according to an exemplary embodiment. The sensors 78 may also include an occupancy sensor 48 configured to determine if the cab 40 is occupied by an operator, passenger, etc. For example, the occupancy sensor 48 may be a pressure sensor configured to determine if a passenger is sitting in the seat 45. In another example, the occupancy sensor 48 may be a motion sensor configured to detect movement inside the cab 40 that may be indicative of a passenger within the cab interior 42. Additional sensors may also be used, including temperature sensors, humidity sensors, air purity sensors, etc. In various embodiments, each of the sensors 78, including the door sensors 46, the window sensors 47, and occupancy sensors 48 may be communicably coupled to the controller 71 and thus may also be communicably coupled to the HVAC system 90.

The controller 71 may also be communicably coupled to an alert device. The alert device 79 may be configured to provide a visual or audible indication to occupants in the vehicle 10 or persons around (i.e., outside of the cab 40 but proximate to) the vehicle 10. According to an exemplary embodiment, the alert device 79 can provide an indication of a current state of the HVAC system 90 or an impending change of a state of the HVAC system 90. For example, the alert device 79 may provide an audible indication that the HVAC system 90 will deactivate in a predetermined amount of time (e.g., within ten seconds, thirty seconds, two minutes, etc.) in response to a detected event (i.e., the door sensor 46 detecting that the door 44 is ajar). The alert device 79 may be an audio speaker, an LED light configured to emit light of various colors, patterns, and sequences, or some other device capable of providing an audible or visual indication related to the operation of the HVAC system 90.

As indicated above, the controller 71 is communicably coupled to the HVAC system 90. The controller 71 may also be communicably coupled to other systems or sub-systems of the vehicle, such as the batteries 60. For example, the controller 71 may receive information, data, or commands from the batteries 60 indicative of a state of charge of the batteries 60, rate of charge decrease resulting from operation of the HVAC system 90, a temperature of the batteries, or some other parameter, etc. The data recorded by the sensors 78, including sensors 46, 47, and 48 may be saved and analyzed in a memory of the controller 71 (e.g., memory 75). Likewise, data transmitted from the HVAC system 90 or other systems/components (e.g., batteries 60) to the controller 71 may be saved and analyzed by the controller 71.

The controller 71 includes a network interface circuit, shown as communication interface 72 that is configured to enable the controller 71 to exchange information over a network. The communication interface 72 can include program logic that facilitates connection of the controller 71 to the network (e.g., a cellular network, Wi-Fi, Bluetooth, radio, etc.). The communication interface 72 can support wireless communications between the controller 71 and other systems, such as a remote monitoring computing system, the batteries 60, or the HVAC system 90. For example, the communication interface 72 can include a cellular modem, a Bluetooth transceiver, a radio-frequency identification (RFID) transceiver, and a near-field communication (NFC) transmitter. In some embodiments, the communication interface 72 includes the hardware and machine-readable media sufficient to support communication over multiple channels of data communication.

The communication interface 72 may also facilitate the transmission of data and commands between the controller 71 and various other systems or devices (e.g., sensors 78, alert device 79, HVAC system 90, batteries 60, operator controls, etc.). In such embodiments, the communication interface 72 may communicate with other systems or devices via an internal communications network, such as a controller area network (CAN bus) or another vehicle electronic communications protocol. Put another way, each of the sensors 78, the alert device 79, the HVAC system 90, and any other communicably coupled systems/components (e.g., batteries 60) may be communicably coupled to the controller 71 via the communication interface 72 using a CAN bus network or similar protocol as is well understood in the art.

The controller 71 is shown to include a processing circuit 73, which further includes a processor 74 and a memory 75. The processor 74 may be coupled to the memory 75. The processor 74 may be a general purpose or specific purpose processor, an application specific integrated circuit (ASIC), one or more field programmable gate arrays (FPGAs), a group of processing components, or other suitable processing components. The processor 74 is configured to execute computer code or instructions stored in the memory 75 or received from other computer readable media (e.g., CDROM, network storage, a remote server, etc.).

The memory 75 may include one or more devices (e.g., memory units, memory devices, storage devices, etc.) for storing data and/or computer code for completing and/or facilitating the various processes described in the present disclosure. The memory 75 may include random access memory (RAM), read-only memory (ROM), hard drive storage, temporary storage, non-volatile memory, flash memory, optical memory, or any other suitable memory for storing software objects and/or computer instructions. The memory 75 may include database components, object code components, script components, or any other type of information structure for supporting the various activities and information structures described in the present disclosure. The memory 75 may be communicably connected to the processor 74 via processing circuit 73 and may include computer code for executing (e.g., by the processor 74) one or more of the processes described herein.

The HVAC management circuit 76 is configured to manage the various operations of the HVAC system 90, including the operations of the various components of the HVAC system 90. More specifically, the HVAC management circuit 76 is configured to control the operation of the blower motor 95, the air curtain system 96, and the seat ventilation system 98, according to an exemplary embodiment. The HVAC management circuit 76 may control the operation of each of these components in response to a command from the operator controls 49, data received from one or more sensors 78, information received from another system/component of the vehicle 10 (e.g., batteries 60), or from some other source (e.g., remote command center, operator’s mobile device, etc.). According to an exemplary embodiment, the HVAC management circuit 76 is configured to direct air via one or more ducts 91(a) of the air circulation system 91 of the of the HVAC system 90. In particular, the HVAC management circuit 76 may direct air via the one or more ducts 91(a) to the cab 40 of the vehicle 10 for heating, cooling, humidity control, or air filtration purposes.

In other embodiments, the HVAC management circuit 76 may cause the air curtain system 96 to create one or more air curtains 97 in response to data from one or more sensors 78. For example, the HVAC management circuit 76 may cause the air curtain system to create an air curtain 97 in the opening of the cab 40 created when a door 44 is ajar. More specifically, a door sensor 46 may detect that the driver’s side door 44 is ajar and may provide a corresponding indication to the controller 71. The HVAC management circuit 76 may prompt the blower motor 95 to deliver air via specific ducts to create an air curtain 97 over the opening of the cab 40 created when door 44 is ajar. The air curtain 97may prevent thermal energy, whether cooling energy or heating energy, within the cab interior 42 from escaping via the opening. Moreover, the air curtain 97 may prevent insects, air borne pathogens, smells, etc. from entering the cab 40 from an external environment.

In another embodiment, the HVAC management circuit 76 may determine that there are two occupants in the cab 40 of the vehicle 10-such as one occupant in zone 42(a) and one occupant in zone 42(b)-and may cause the air curtain system 96 to create an air curtain 97 between zone 42(a) and 42(b) in order to maintain separate climate controls for each zone 42(a), 42(b). The HVAC management circuit 76 may determine that two occupants are present in the cab based on data received from occupancy sensors 48. As noted above, the air curtain 97 may be created by directing air through one or more specific ducts 91(a) configured to produce a controlled stream of air from a roof of the cab 40 down to a floor (or center console, etc.) of the cab so as to divide zone 42(a) and 42(b). Moreover, the HVAC management circuit 76 may be configured to create an air curtain 97 dividing zones 42(a) and 42(b) in response to a determination that only one occupant (i.e., a driver of the vehicle 10) is present within the cab interior 42. Relatedly, the HVAC management circuit 76 may also deactivate or stop the operation of the air circulation system 91, cooling system 92, heating system 93, or humidity control system 94 to alter the climate of zone 42(b). Accordingly, the air curtain 97 may separate zone 42(a) from 42(b) so that the HVAC system 90 is only operating to alter the climate of zone 42(a). Operating the HVAC system 90 in such a way bolsters the efficiency of the HVAC system 90 by limiting or preventing unnecessary operation or unnecessary thermal losses.

In yet other embodiments, the HVAC management circuit 76 may cause a divider 43 to partition zone 42(a) from zone 42(b) (rather than creating an air curtain 97) in response to an operator command, data from sensors 78, or otherwise. As with the previous example, the HVAC management circuit 76 may also deactivate or stop the operation of the air circulation system 91, cooling system 92, heating system 93, or humidity control system 94 from operating to alter the climate of zone 42(b). The deactivation of such operations within zone 42(b), along with the placement of a physical divider (i.e., vinyl screen, plexiglass sheet, etc.) between zones 42(a) and 42(b) thereby reduces the heating and cooling demands of the HVAC system 90 to further reduce energy consumption. In other embodiments, the divider 43 is controlled by another system of the vehicle 10, via the control system 70 or otherwise.

As indicated above, the HVAC management circuit 76 may be configured to control the operation of the HVAC system 90 and related components based on an input received from an operator. For example, the HVAC management circuit 76 may control the heating or cooling operations of the HVAC system 90 based on an operator input provided via operator controls 49. The operator controls 49 may be a touch-screen user interface, a plurality of buttons, switches, dials, and the like, voice-operated controls, or otherwise. In another embodiment, the HVAC management circuit 76 may control the operation of the HVAC system 90 based on information, data, or commands received from a third party (e.g., remote fleet manager, remote dispatch center, etc.). Such information, data, or commands, may be received via a wireless communication means, as described above.

In various embodiments, the HVAC management circuit 76 may be configured to alter the operation of the HVAC system 90 and related components for the purpose of bolstering efficiency of the HVAC system 90 and reducing wasteful, energy intensive operation. For example, the HVAC management circuit 76 may limit the amount of cooling energy or heating energy that may be supplied to the cab 40 based on factory-specified presents, a measured ambient temperature or humidity, a state of charge of the batteries 60, or some other parameter. Similarly, the HVAC management circuit 76 may selectively cause air to circulate via specific ducts 91(a) of the air circulation system 91 to improve efficiency. In yet another embodiment, the HVAC management circuit 76 may alter the operation of the blower motor 95 to reduce the power consumed by the HVAC system 90 to alter the climate of the cab 40.

The HVAC interlock circuit 77 can alter the operation of the HVAC system 90 in various scenarios. The HVAC interlock circuit 77 can alter the operation of the HVAC system 90 in response to data, information, or commands from sensors 78, other vehicle systems (e.g., batteries 60), an operator input, a remote dispatch center, or otherwise. The HVAC interlock circuit 77 can alter the operation of one or more components of the HVAC system 90, such as the blower motor 95, cooling system 92, heating system 93, humidity control system 94, blower motor 95, air curtain system 96, or seat ventilation system 98, in various ways. For example, the HVAC interlock circuit 77 can: (a) turn off the HVAC system 90 altogether; (b) keep the blower motor 95 running while turning off other components of the HVAC system 90; (c) provide heating or cooling for the batteries 60 while ceasing the heating or cooling for the cab 40; (d) deactivate the heating or cooling for one of the zones 42(a) and 42(b) of the cab 40; (e) limit the amount of cooling or heating energy that can be provided to the cab 40; (f) discontinue certain heating operations while continuing others (e.g., heating energy to defrost windows); (g) limit a temperature range within which cooling energy or heating energy may be provided to the cab 40; (h) limit a humidity range within which the humidity can be maintained; (i) cause one or more air curtains 97 or dividers 43 to operate; (j) control the one or more ducts 91(a) to selectively direct air flow to certain areas of the cab 40; (k) control the one or more ducts 91(a) to control the volume of air flow to the cab 40; or (j) alter the timing of a shutoff operation for the HVAC system 90 or components thereof. As will be appreciated, the HVAC interlock circuit 77 can control the various components of the HVAC system 90 individually or in various combinations and in ways beyond those mentioned above.

The HVAC interlock circuit 77 may alter the operation of the HVAC system 90 and various components in certain interlock scenarios. When an interlock scenario is detected, the HVAC interlock circuit 77 may control the HVAC system 90 and various related components in one or more of the ways discussed above. For example, the HVAC interlock circuit 77 can cause the HVAC system to operate in an interlock mode, where an operation of the HVAC system is altered, modified, controlled, halted, or otherwise affected. In one embodiment, the HVAC interlock circuit 77 may detect that a door 44 is ajar and cause the HVAC system 90 to create one or more air curtains 97 to prevent a temperature or humidity change within the cab interior 42 with the HVAC system operating in the interlock mode. In such embodiments, the HVAC interlock circuit 77 may determine that the door is ajar based on data received from the door sensor 46 that indicates that the door 44 is ajar. In another embodiment, the HVAC interlock circuit 77 may determine that the door 44 is ajar based on a rate of temperature change as measured by one or more temperature sensors positioned within the cab interior 42. For example, an increased rate of temperature change may indicate that the door 44 or a window of the door 44 is open and causing the temperature of the cab interior 42 to change according to an ambient temperature. In this way, the HVAC interlock circuit 77 may indirectly (i.e., without using a door sensor 46) determine that a door 44 or window is open and correspondingly alter the operation of the HVAC system 90 to, for example, create an air curtain 97, limit the cooling or heating energy delivered to the cab interior 42, or in some other way as discussed above.

In another embodiment, the HVAC interlock circuit 77 may alter the operation of the HVAC system 90 based on a measured temperature differential between an ambient temperature outside of the cab 40 and a temperature within the cab interior 42. For example, if the measured temperature differential indicates a significant differential (e.g., 70° F., 80° F., etc.), the HVAC interlock circuit 77 may prevent the HVAC system from delivering further heating energy or cooling energy to the cab interior 42. In yet another embodiment, the HVAC interlock circuit 77 may alter the operation of the HVAC system 90 based on a measured humidity differential between an ambient humidity and a humidity within the cab interior 42. In such embodiments, the HVAC interlock circuit 77 can alter the operation of the HVAC system 90 by modifying the timing of a shutoff operation whereby the HVAC system 90 or various components thereof are turned off indefinitely or for a predetermined amount of time. For example, the HVAC interlock circuit 77 may determine, based on a temperature or humidity differential, that various HVAC system 90 operations can be stopped.

In various embodiments, the HVAC interlock circuit 77 may alter an operation of the HVAC system 90 in multiples, such as by limiting the cooling or heating energy supplied to the cab interior 42 and by creating an air curtain 97, in response to one or more interlock conditions. In other embodiments, the HVAC interlock circuit 77 may alter an operation of the HVAC system 90 in a particular manner based on a particular combination of detected interlock conditions, such as a determination that the door 44 is ajar while a temperature differential exceeds a certain threshold (e.g., a threshold temperature). In other embodiments, the presence of a single interlock condition can cause the HVAC interlock circuit 77 to alter an operation of the HVAC system 90.

The HVAC interlock circuit 77 of the controller 71 may be programmed to automatically operate in a particular manner based on manufacturer-defined settings such that operator input is not required. More specifically, the HVAC interlock circuit 77 may operate according to a set of HVAC interlock rules or commands that pertain to the aforementioned interlock conditions and/or the corresponding effects to the operation of the HVAC system 90. In some embodiments, an operator may modify, suspend, disable, or create HVAC interlock rules or commands to alter the operation of the HVAC interlock circuit 77. In such embodiments, the operator may modify, suspend, disable, or create HVAC interlock rules or commands via one or more user interface components (e.g., a touch screen, a plurality of buttons or switches, etc.). In another embodiment, the HVAC interlock circuit 77 may be programmed entirely based on operator inputs. In such embodiments, an operator or fleet manager associated with the vehicle 10 may prescribe various HVAC interlock rules.

The vehicle 10 may further include a battery cooling system that is configured to regulate the temperature of the batteries 60 in order to maintain a desired operating temperature of the batteries 60. In some embodiments, the battery cooling system may provide cooling energy to the batteries 60 via cooled liquid (e.g., water, refrigerant, coolant, etc.), cooled air, a combination thereof, or some other cooling means as is well understood in the art. In various embodiments, the battery cooling system is a separate system from the HVAC system 90. In other embodiments, the battery cooling system part of the HVAC system 90 or is operationally coupled to the HVAC system 90 such that the operation of the HVAC system 90 may affect the operation of the battery cooling system.

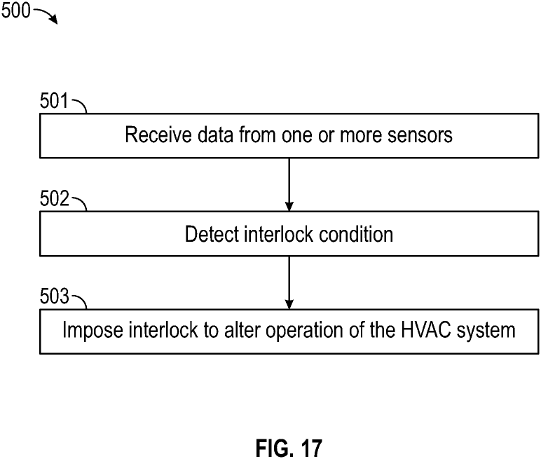

Referring now to FIG. 17, a flow chat of a method 500 is shown. The method 500 relates to the operation of the HVAC interlock circuit 77 as discussed above with reference to FIG. 16. Accordingly, the method 500 may be performed by the controller 71 of the control system 70. More specifically, the method 500 can be performed by the processor 74 that executes instructions stored in the memory 75 of the controller according to the HVAC interlock circuit 77.

At process 501, the HVAC interlock circuit 77 may receive data from one or more sensors 78 regarding the current state of the vehicle 10, the HVAC system 90, occupants within or around the vehicle 10, or otherwise. For example, the HVAC interlock circuit 77 may determine a temperature differential between a temperature within the cab interior 42 and an ambient temperature. In another example, the HVAC interlock circuit 77 can determine the number of occupants within the cab interior 42 based on information received from one or more occupancy sensors 48. In yet another example the HVAC interlock circuit 77 may determine that a door 44 of the cab is ajar based on information received from a door sensor 46. In still another embodiment, the HVAC interlock circuit 77 may determine that a window of a door 44 is open based on information received from a window sensor 47. In another embodiment, the HVAC interlock circuit 77 may determine that the state of charge of the batteries 60 approaches a certain threshold state of charge. As will be appreciated, and as discussed above, any number of different scenarios may be detected by the HVAC interlock circuit 77 according to information provided by the sensors 78 and other vehicle systems (e.g., batteries 60).

At process 502, the HVAC interlock circuit 77 may detect, based on the data received at process 501, that an HVAC interlock condition is present. More specifically, the HVAC interlock circuit 77 may determine, based on the data received at process 501 that one of the HVAC interlock rules is satisfied. As noted above, the HVAC interlock rules may be preset by a fleet manager or vehicle manufacture, specified by an operator, or otherwise. For example, the HVAC interlock circuit 77 may determine that an interlock condition is present when a door 44 is ajar. In another example, the HVAC interlock circuit 77 may determine that an interlock condition is present when only one occupant is in the cab 40 (e.g., within the cab interior 42). In another embodiment, the HVAC interlock circuit 77 may determine that an interlock condition is present when a state of charge of the batteries 60 approaches a threshold value. As will be appreciated, and as discussed above, any number of different interlock conditions may be implemented.

At process 503, the HVAC interlock circuit 77 can alter an operation of the HVAC system 90 based on the interlock condition detected at process 502. As discussed above, a response of the HVAC interlock circuit 77 to a detected interlock condition may depend on the various HVAC interlock rules prescribed by a manufacturer, fleet manager, operator, etc. In one example, the HVAC interlock circuit 77 may cause the air curtain system 96 to create an air curtain 97 proximate to a door 44 after an interlock condition related to an open door 44 is present. In another example, the HVAC interlock circuit 77 may create an air curtain 97 between zones 42(a) and 42(b) of the cab interior 42 based on an interlock condition related to partial occupancy of the cab 40. In yet another embodiment, the HVAC interlock circuit 77 may limit a temperature range for the heating and cooling energy produced by the HVAC system 90 in response to an interlock condition triggered by measured temperature differential between the cab interior 42 and an ambient temperature. The HVAC interlock circuit 77 can alter (e.g., decrease or increase) a rate of heating or cooling or alter (e.g., decrease or increase) a rate of air circulation in response to an interlock condition triggered by measured temperature differential between the cab interior 42 and an ambient temperature.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data that cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A refuse vehicle, comprising:
a chassis;
a cab;
a body assembly coupled with the chassis, the body assembly defining a refuse compartment;
a lift assembly configured to engage a refuse container;
a heating, ventilation, or air conditioning (HVAC) system to deliver air to the cab via a plurality of ducts; and
a controller configured to:
receive data from one or more sensors;
determine, based on the received data, that an interlock condition is present; and
alter an operation of the HVAC system based on the interlock condition.

2. The refuse vehicle of claim 1, further comprising:
a door configured move between a closed position and an open position, wherein the door provides access to an opening of the cab with the door in the open position; and
a door sensor configured to determine whether the door is in the open position or the closed position,
wherein the received data from the door sensor indicates that the door is in the open position.

3. The refuse vehicle of claim 2, wherein the plurality of ducts comprises at least one duct configured to create an air curtain proximate the opening,
wherein the controller causes the HVAC system to create the air curtain proximate the opening.

4. The refuse vehicle of claim 1, wherein the one or more sensors includes a first temperature sensor and a second temperature sensor, the first temperature sensor configured to determine a temperature within the cab, the second temperature sensor configured to determine an ambient temperature outside of the cab, wherein the interlock condition is present based on a differential between the temperature within the cab and the ambient temperature.

5. The refuse vehicle of claim 1, wherein the controller is configured to alter the operation of the HVAC system by at least one of shutting off the HVAC system, altering a rate of heating or cooling, or altering a rate of air circulation.

6. The refuse vehicle of claim 1, wherein the controller is further configured to provide, prior to altering the operation of the HVAC system, an indication to an operator of the refuse vehicle that the operation of the HVAC system will be altered.

7. The refuse vehicle of claim 1, wherein the one or more sensors comprises a first occupancy sensor and a second occupancy sensor, the first occupancy sensor configured to determine whether a first zone of the cab is occupied, the second occupancy sensor configured to determine whether a second zone of the cab is occupied.

8. The refuse vehicle of claim 7, wherein the received data indicates that one of the first zone or the second zone is unoccupied.

9. The refuse vehicle of claim 8, wherein altering the operation of the HVAC system comprises causing an air circulation system to create an air curtain between the first zone and the second zone within the cab.

10. The refuse vehicle of claim 1, further comprising one or more batteries, wherein the interlock condition is present based on a state of charge of the one or more batteries.

11. The refuse vehicle of claim 1, wherein the controller is configured to alter the operation of the HVAC system until the interlock condition is no longer present.

12. A control system for a heating, ventilation, or cooling (HVAC) system of a refuse vehicle, comprising:
a controller configured to control an operation of the HVAC system of the refuse vehicle, the HVAC system configured to provide heating or cooling energy to a cab of the refuse vehicle, the controller comprising one or more processors and a memory storing instructions that, when executed by the one or more processors cause the one or more processors to perform operations comprising:
receive data from one or more sensors regarding a condition of the cab of the refuse vehicle;
detect, based on the received data, that an interlock condition is present; and
alter, based on the detected interlock condition, the operation of the HVAC system.

13. The control system of claim 12, wherein the HVAC system comprises an air circulation system configured to create an air curtain within the cab of the refuse vehicle, wherein altering the operation of the HVAC system causes the air circulation system to create the air curtain.

14. The control system of claim 12, wherein the one or more sensors comprises a door sensor configured to determine when a door of the cab is ajar, wherein the interlock condition is present based on the received data indicating that the door is ajar.

15. The control system of claim 14, wherein the one or more sensors further comprises a temperature sensor configured to determine a temperature within the cab, wherein the received data indicates that the door is ajar and that the temperature within the cab is beyond a threshold temperature.

16. The control system of claim 12, wherein the one or more sensors comprises a door sensor configured to determine when a door of the cab is ajar, wherein the received data indicates that the door is ajar, wherein altering the operation of the HVAC system comprises causing an air circulation system to create an air curtain between the door and an interior of the cab.

17. The control system of claim 12, wherein the one or more sensors comprises a first occupancy sensor and a second occupancy sensor, the first occupancy sensor configured to determine whether a first zone of the cab is occupied, the second occupancy sensor configured to determine whether a second zone of the cab is occupied.

18. The control system of claim 17, wherein the received data indicates that one of the first zone or the second zone is unoccupied, wherein altering the operation of the HVAC system comprises causing an air circulation system to create an air curtain between the first zone and the second zone within the cab.

19. A method of operating a heating, ventilation, or cooling (HVAC) system of a refuse vehicle, comprising:
receiving, by a controller from one or more sensors, data regarding a condition of an interior of a cab of the refuse vehicle;
detecting, by the controller and based on the data regarding the condition of the interior of the cab, that an interlock condition is present; and
causing, by the controller and based on the detected interlock condition, the HVAC system to operate in an interlock mode until the interlock condition is no longer satisfied.

20. The method of claim 19, wherein operating the HVAC system in the interlock mode includes causing an air circulation system to create an air curtain within the cab of the refuse vehicle.
